(19) United States
(12) Patent Application Publication
(10) Pub. No.: US 2004/0168649 A1
(43) Pub. Date: Sep. 2, 2004

(54) Artificial reef

(75) Inventors: Larry Harper, Clinton, KY (US); Steve Larkin, Columbus, KY (US)

Correspondence Address: MACMILLAN SOBANSKI & TODD, LLC, ONE MARITIME PLAZA FOURTH FLOOR, 720 WATER STREET, TOLEDO, OH, 43604-1619, US

(73) Assignee: Cedars, Ltd., Fulton, KY

(21) Appl. No.: 10/765,225

(22) Filed: Jan. 26, 2004

Related U.S. Application Data
(60) Provisional application No. 60/442,972, filed on Jan. 27, 2003.

(51) Int. Cl. A01K 61/00

(52) U.S. Cl. 119/221

(57) ABSTRACT

An artificial reef for attracting fish is disclosed wherein the reef includes a main body of spherical shape; and a plurality of elongate members extending radially outwardly therefrom.

### CROSS-REFERENCE TO RELATED APPLICATION

This application claims the benefit of U.S. provisional patent application Serial No. 60/442,972 filed Jan. 27, 2003.

### BACKGROUND OF THE INVENTION

1. Field of the Invention

The present invention relates to a structure for attracting fish and more particularly to an artificial reef and a method of making the same.

2. Description of the Prior Art

Considerable research has been accomplished for methods and structures for attracting both sport and commercial fish in bodies of water such as lakes and streams in the United States as well as other parts of the world.

It has been found that the provision of artificial reefs has successfully caused the congregation of fish in many areas of the world. Fish naturally seek areas where food may be available and shelter is provided from predators. Normally, ocean reefs, seaweed beds, grassy areas, and rocky areas are exemplary of locations which afford a supply of food and afford some degree of protection from predators. Manifestly, such areas are not always available. Accordingly, it has been found that artificial reefs can be utilized in certain areas to provide attraction for fish to congregate and breed. Different types of materials have been used to form artificial reefs with varying success. Cost and attendant aesthetics are matters which must be considered.

An object of the present invention is to produce an artificial fish attracting reef which can be economically manufactured.

Another object of the invention is to produce an artificial reef from components formed of a lightweight material which may be readily and easily transported to a selected site and assembled on site without the requirement of special skills or expensive tools.

Another object of the invention is to produce an artificial reef for attracting fish which is formed of an inert material having a long duty cycle.

### SUMMARY OF THE INVENTION

The above objects may be achieved by an artificial reef for attracting fish comprising a main body formed of a plastic material, the body having an outer surface and a plurality of spaced apart apertures formed in outer surface; and a plurality of elongate members, each of the members having a distal end and a proximal end, the proximal ends of the members inserted into respective apertures of the main body, whereby the distal ends of the members are disposed in spaced relation from the main body.

### BRIEF DESCRIPTION OF THE DRAWINGS

The above as well as other objects and advantages of the invention will become readily apparent to those skilled in the art from reading the following detailed description of a preferred embodiment of the invention when considered in the light of the attached drawings, in which:

FIG. 1 is a perspective view of an assembled artificial reef incorporating the features of the invention;

FIG. 2 is an elevational view of the main body of an artificial reef embodying the features of the present invention; and

FIG. 3 is an elevational view of the main body illustrated in FIG. 1 showing radially outwardly extending cylindrical inserts.

### DETAILED DESCRIPTION OF THE PREFERRED EMBODIMENT

Referring to the drawings, there is illustrated an artificial reef embodying the features of the present invention. More particularly, there is illustrated a main body 10 having an inner member 12 (clearly illustrated in FIG. 2) and an outer peripheral shell 14. Aligned apertures 16 are formed to extend inwardly through the outer shell 14 and terminating short of the center of inner member 12.

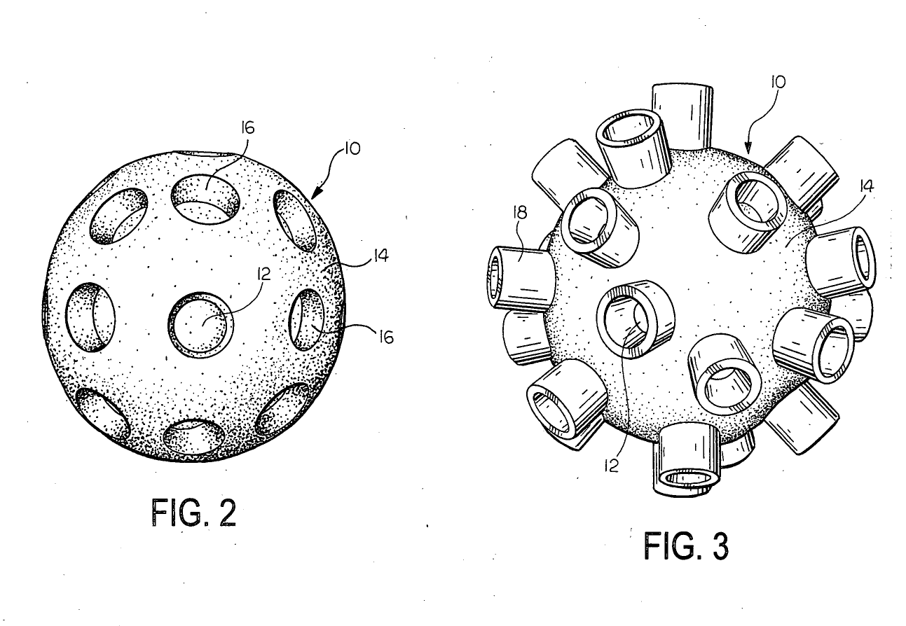

A plurality of cylindrical inserts 18 (clearly shown in FIG. 3) are inserted into respective apertures 16. It will be appreciated that only a single insert 18 is received within each of the apertures 16.

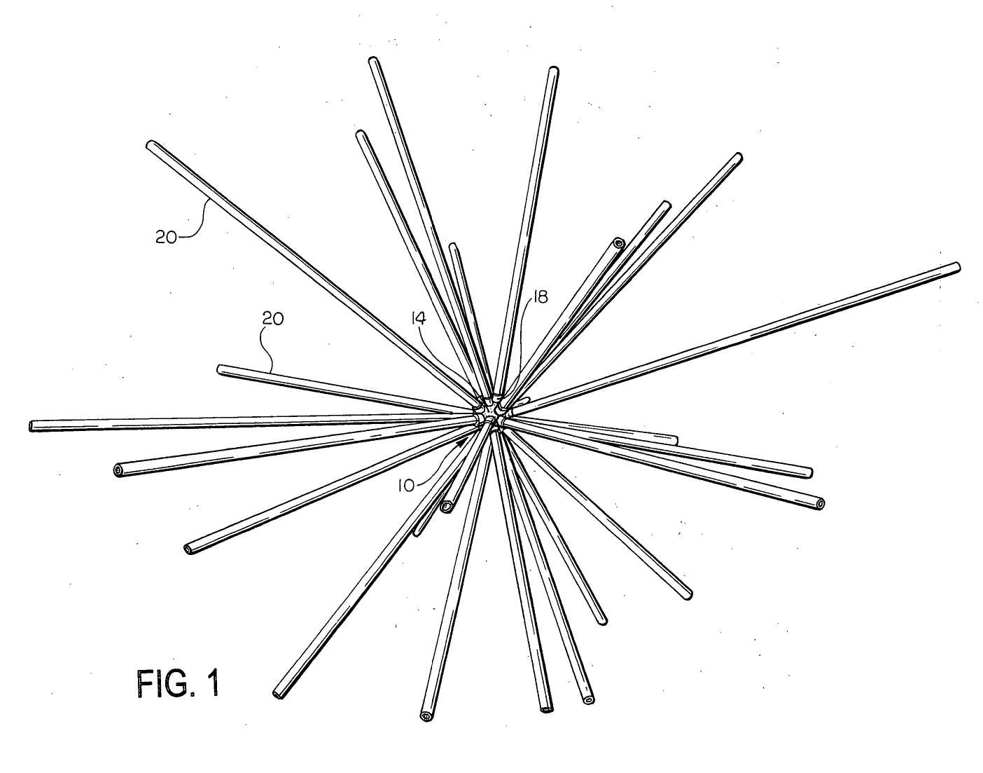

Each of the inserts 18 receives the proximal end of one of a plurality of elongate tubes 20. In the assembled form, as illustrated in FIG. 1, the distal ends of the tubes 20 are disposed at spaced relation away from the outer surface of the main body 10. In the preferred embodiment of the invention, fifteen (15) of the tubes 20 are of a length of approximately 36 inches, and eleven (11) of the tubes 20 are of a length of approximately 46 inches.

The preferred embodiment of the invention, the main body 10 is spherical in shape and is typically formed of a polyvinyl chloride resin. It will be understood that other shapes and polymers and copolymers may be utilized without departing from the spirit of the invention.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. An artificial reef for attracting fish comprising:
a main body having an outer surface and a plurality of spaced apart apertures formed therein; and
a plurality of elongate members, each of said members having a distal end and a proximal end, the proximal ends of said members inserted into respective apertures of said main body, whereby the distal ends of said members are disposed in spaced relation from said main body.

2. The invention defined in claim 1 wherein said main body is formed of a plastic material.

3. The invention defined in claim 2 wherein said plastic material is polyvinyl chloride.

4. The invention defined in claim 1 wherein said main body is comprised of a central core member and a peripheral outer shell.

5. The invention defined in claim 1 wherein said elongate members are hollow.

6. The invention defined in claim 1 wherein said elongate tubes are formed of plastic material (polyvinyl chloride).

7. The invention defined in claim 6 wherein said plastic material is polyvinyl chloride.

8. The invention defined in claim 1 wherein said elongate members are different lengths.

9. The invention defined in claim 1 wherein said elongate members include a first group of members of a predetermined length and at least a second group of members of a different length.

10. An artificial reef for attracting fish comprising:
a main body of spherical shape; and
a plurality of elongate members extending radially outwardly from said body.

11. The invention defined in claim 10 wherein said elongate members include a proximal end and a distal end.

12. The invention defined in claim 11 wherein said main body is provided with a plurality of apertures for receiving the proximal ends of respective ones of said elongate members.

13. The invention defined in claim 11 including an insert snuggly disposed in each of the apertures in said main body, said insert receiving the proximal end of the respective elongate members.

14. The invention defined in claim 10 wherein said main body includes an inner spherical member and an outer spherical member.

15. The invention defined in claim 14 wherein the outer member is provided with a plurality of apertures for supportingly receiving respective ones of said elongate members.

16. The invention defined in claim 15 wherein said elongate members are hollow tubes.
